(19) United States
(12) Patent Application Publication
(10) Pub. No.: US 2022/0232760 A1
(43) Pub. Date: Jul. 28, 2022

(54) DISC MULCHER DRIVE SYSTEM

(71) Applicant: Diamond Mowers, LLC, Sioux Falls, SD (US)

(72) Inventor: Zachary Shelby Wood, Brandon, SD (US)

(21) Appl. No.: 17/553,973

(22) Filed: Dec. 17, 2021

Related U.S. Application Data
(60) Provisional application No. 63/141,648, filed on Jan. 26, 2021.

(51) Int. Cl. A01D 34/00; A01D 34/73; A01D 34/52

(52) U.S. Cl. CPC A01D 34/005; A01D 2101/00; A01D 34/52; A01D 34/73

(57) ABSTRACT

A disc mulcher can be connectable to a carrier vehicle and can include a frame connectable to the skid steer, a spindle, a disc, and a variable speed motor. The spindle assembly can be connected to the frame. The disc can be connected to spindle assembly and can be rotatable relative to the frame about a central axis of the disc and the spindle assembly. The variable speed motor can be connected to the frame and can be indirectly coupled to the spindle assembly. The variable speed motor can be operable to rotate the disc.

### CLAIM OF PRIORITY

This patent application claims the benefit of priority, under 35 U.S.C. Section 119(e), to Zachary Wood, U.S. Patent Application Ser. No. 63/141,648, entitled “DISC MULCHER DRIVE SYSTEM,” filed on Jan. 26, 2021 (Attorney Docket No. 5664.002PRV), which is hereby incorporated by reference herein in its entirety.

### BACKGROUND

Mulchers are devices commonly used for the removal of forestry, such as trees and brush. Mulchers can be connectable to machinery, such as a skid steer, and can be manipulated and operated by the machinery. For example, mulchers can be connected to skid steers and can be operated to grind down tree stumps. Mulchers are often either drum mulchers or disc mulchers, where a drum mulcher includes a large spinning drum and a disc mulcher includes a large spinning disc. With both types, teeth or cutting tools are attached to the mulcher to engage fibrous material (such as a tree stump) for removal of the material.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A illustrates a top isometric view of a disc mulcher.

FIG. 1B illustrates a top isometric view of a disc mulcher.

FIG. 1C illustrates a top isometric view of a disc mulcher.

FIG. 2 illustrates a bottom view of a disc mulcher.

FIG. 3 illustrates an enlarged top isometric view of a portion of a disc mulcher.

FIG. 4 illustrates an enlarged top isometric view of a portion of a disc mulcher.

FIG. 5A illustrates a cross-sectional view of a portion of a disc mulcher.

FIG. 5B illustrates a cross-sectional view of a portion of a disc mulcher.

FIG. 6 illustrates a graph of operating torque of various disc mulchers.

### DETAILED DESCRIPTION

Disc mulchers are a common mulcher type for removal of forestry, such as trees, brush, and tree stumps. Disc mulchers commonly use a motor mounted directly to a spindle where a shaft of the spindle connects to a mulching disc mounted below a frame of the mulcher. Motors are commonly hydraulically powered to rotate the shaft of the spindle assembly to rotate the disc to clear forestry. However, using a motor connected directly to the shaft means that the disc must rotate at the same speed as the motor. Further, because the disc is relatively large it must be mounted at or near a center of a frame of the mulcher, which requires the directly coupled motor to also be mounted at or near the center. Such placement of the motor can impede an operator's vision of the disc during operation.

The inventors have recognized that an indirectly driven disc can allow the motor to be moved away from the center of the frame, helping to provide operators with better vision of the disc during cutting operations. Also, using an indirect drive arrangement allows the motor to spin at a different speed than the spindle through the use of gears (pulleys) and belts or chains. This can allow for use of a motor at an optimized size and speed for the cutting operation and can allow for a multi-speed motor to be used more effectively and efficiently.

The above discussion is intended to provide an overview of subject matter of the present patent application. It is not intended to provide an exclusive or exhaustive explanation of the invention. The description below is included to provide further information about the present patent application.

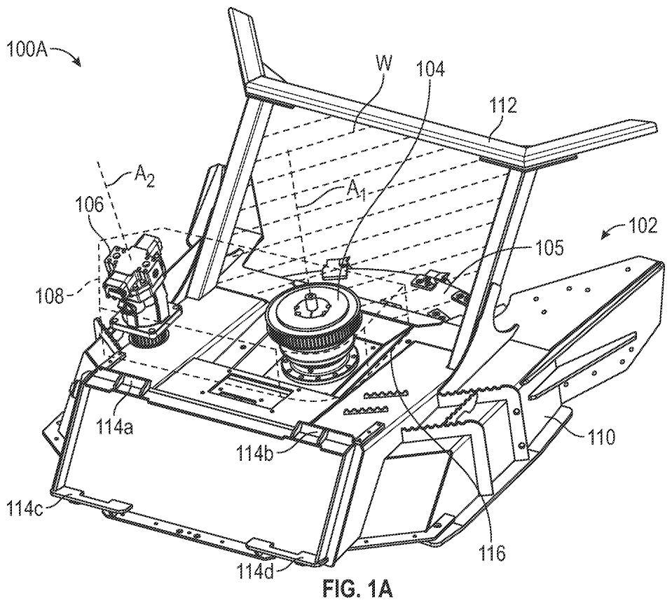

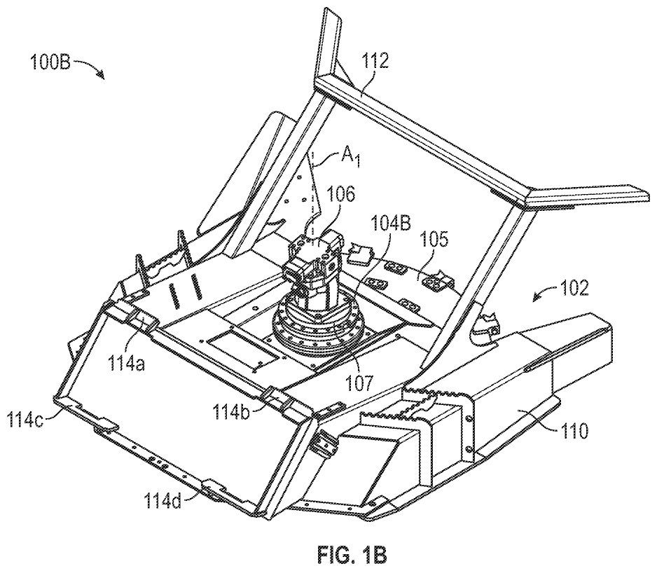

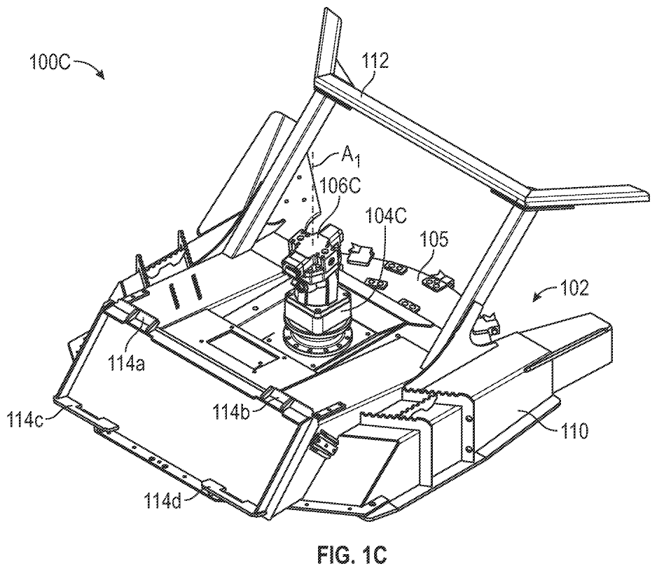

FIG. 1A illustrates a top isometric view of a disc mulcher 100A. The disc mulcher 100A can include a frame 102, a spindle assembly 104, a disc 105, a motor assembly 106, and a cover 108. The frame 102 can include panels 110, tube members 112, and connection points 114a-114d.

Generally, the disc mulcher 100A can be a mulcher configured to engage fibrous materials with the disc 105, such as brush, trees, bushes, or the like. The disc mulcher 100A can be connectable to various carrier vehicles such as a skid steer, a wheeled excavator, a tracked excavator, a wheeled feller buncher, a tracked feller buncher, a forestry mulching tractor, or the like.

The frame 102 can be a rigid or semi-rigid assembly connectable to a skid steer at the connection points 114a-114d. The frame can be made of welded steel, but can be made of other materials in other examples, such as one or more of metals, plastics, foams, elastomers, ceramics, composites, combinations thereof, or the like. The tube members 112 of the frame 102 can generally provide structural support for the disc 105 and the panels 110, which can cover the disc 105 to help limit propulsion of debris during operation of the disc 105. The tube members 112 can also provide protection to the user, the mulcher 100A, and the skid steer from falling debris.

The cover 108 can also be made of steel or other materials and can be connected to the frame 102 by a hinge 116. The hinge 116 can be a multi-part hinge, such as two sets of knuckles and a pin where one set of knuckles connects to the frame 102 and the other set connects to the cover 108. The hinge 116 can allow the cover 108 to pivot or move for access to the spindle assembly 104 or the motor assembly 106, such as for service thereof. The cover 108 can be optionally securable to the frame 102 in one or more locations, such as using one or more fasteners secured to the cover 108 and to the frame 102.

The disc 105 can be a disc-shaped member connected to the spindle assembly 104 to secure the disc 105 to the frame 102. The disc 105 can be a large diameter disc (e.g., 60 inches or 1.5 meters) with a relative small thickness or height. In other examples, the disc 106 can be other sizes, such as 0.1 meters to 5 meters. The disc 105 can be made of one or more metals (or alloys or composites) and can be configured to support cutting blades or teeth for engaging fibrous materials, such as trees.

The spindle assembly 104 can be a pulley and bearing assembly connecting the disc 105 to the frame 102 and connecting the motor assembly 106 to the disc 105, indirectly, thereby allowing the motor assembly 106 to drive the disc 105 to rotate with respect to the frame 102. The spindle assembly 104 can include various bearings, seals, and coupling features, as discussed in further detail below. The spindle assembly 104 can be mounted to the frame about a central axis A1 that can be near or at a central portion of the disc 105 and optionally at or near a central portion of the frame 102.

As discussed in further detail below, the motor assembly 106 can include a motor and a pulley secured to the frame 102 and coupled to the spindle assembly 104, such as via a belt or chain. The motor assembly 106 can be connected to hydraulic lines to receive pressurized hydraulic fluid from the skid steer. The motor assembly 106 can be connected to the frame in alignment with the axis A2 that can be at a location laterally offset from the central axis A1.

FIG. 1A shows a viewing area W in phantom diagonal lines, which can represent a viewing window of a front portion of the disc 105 from an operator's perspective. By offsetting the motor assembly 106 from the central axis A1, the viewing area or window W can provide an unobstructed or less obstructed view of the front portion of the disc 105 than a directly-driven motor and spindle assembly. Also, the motor assembly 106 can be positioned forward enough to avoid contact with components of the skid steer when attached.

In operation of some examples, when the disc mulcher 100A is connected to a skid steer, hydraulic fluid can be delivered to the motor to cause the pulley to spin to rotate the spindle assembly 104 and the disc 105 with respect to the frame 102. The disc 105 can engage fibrous material, such as a tree for shredding or mulching of the tree. The two-speed motor of the motor assembly 106 can be used to operate the mulcher at a relatively higher speed to increase torque and therefore cutting power and helping to lower required power input from the carrier, which can help to create a more efficient and effective disc mulcher.

Because the motor assembly 106 is indirectly coupled to the spindle assembly, the motor assembly 106 can include a motor that operates at a speed different than a speed of the disc 105, such as the motor of the motor assembly 106 can operate at a speed higher than a speed of the disc 106, which can allow the motor to be relatively smaller and less expensive. Also, because the motor assembly 106 is indirectly connected to the spindle assembly, failure of the motor assembly 104 can have a lesser impact on the spindle assembly 104 versus a direct coupling of a motor and spindle assembly. Further details of the disc mulcher 100A are discussed below.

FIG. 1B illustrates a top isometric view of a disc mulcher 100B. The disc mulcher 100B can be similar to the disc mulcher 100A discussed above; the disc mulcher 100B can differ in that the motor assembly 106 can be mounted in axial alignment or substantial axial alignment with a spindle assembly 104B. Substantial axial alignment can mean that axes of a drive shaft of the spindle and a drive shaft of the motor assembly 106 are in alignment or are nearly in alignment such that the Axis A1 can represent both axes of the motor assembly 106 and the spindle assembly 104.

Optionally, a transmission 107 can be connected to the motor assembly 106 and connected to the spindle assembly 104 (e.g., shaft of the spindle assembly 104). Optionally, the transmission 107 can be mounted vertically above the spindle assembly, which can help allow for axial alignment of the motor assembly 106 and the spindle assembly 104. The transmission 107 can be a planetary gear assembly, a multi-stage gear assembly, a constantly variable transmission, or the like. Optionally, the axes of the motor assembly 106 and the spindle assembly 104 can be offset and the motor assembly 106 when the transmission 107 is mounted vertically.

The transmission 107 can be configured to transmit rotational forces from the motor assembly 106 to the spindle assembly 104 at a speed different from that of the motor assembly 106, allowing for the motor assembly 106 to operate at a higher or lower speed than the disc 105. Use of a motor assembly 106 including a motor that spins at a speed higher than that of the disc 105, for example, can allow the motor assembly 106 to be relatively lower in cost and higher in efficiency.

FIG. 1C illustrates a top isometric view of a disc mulcher 100C. The disc mulcher 100C can be similar to the disc mulcher 100B discussed above; the disc mulcher 100C can differ in that the transmission 107 can be omitted and the motor assembly 106 can be a variable speed motor or can be driven by a variable speed drive, allowing the motor assembly 106 to operate the disc 105 at varying speeds.

In some examples, the motor assembly 106 can include a variable speed hydraulic motor. In some examples, the motor assembly 106 can include a variable speed electric motor. Optionally, the motor assembly 106 can include an electric motor operated by a variable speed drive (or a variable frequency drive, an adjustable speed drive, an adjustable frequency drive, or the like). Use of a variable speed system can allow for slow-start to be used, can help to optimize cutting speed and torque, and can eliminate the need for a transmission, which can save cost. Use of a variable speed system can also help to increase overall operational torque, which can improve cutting and mulching performance of the disc 105.

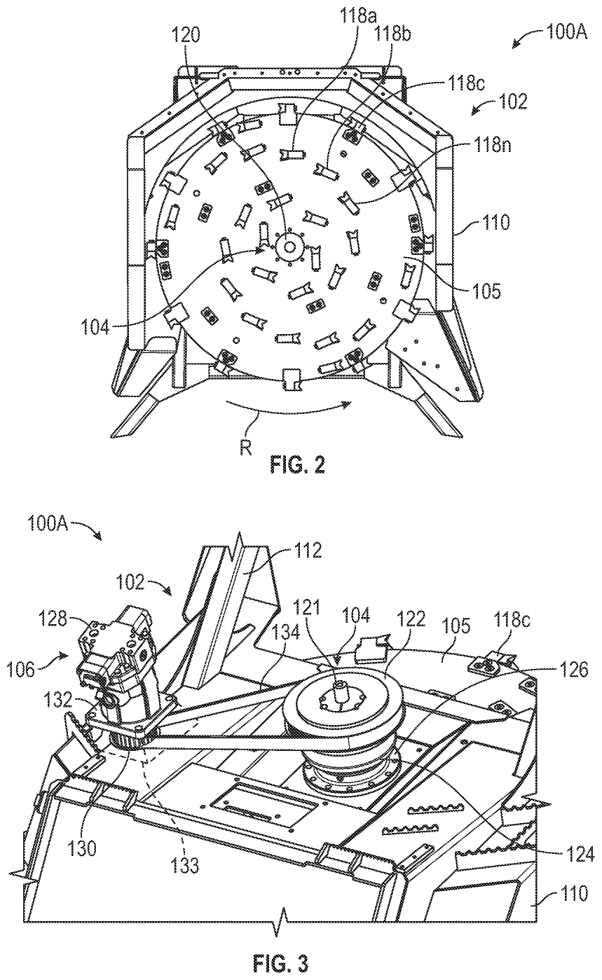

FIG. 2 illustrates a bottom view of the disc mulcher 100A. The disc mulcher 100A of FIG. 2 can be consistent with the disc mulcher 100A of FIG. 1A; FIG. 2 shows additional details of the disc mulcher. For example, FIG. 2 shows that the disc 105 can include teeth or bits 118a-118n. The teeth 118a-119n can be rotatable with the disc 105 to engage fibrous material (such as trees) for mulching or shredding of the material. The teeth 118 and the disc 105 can be rotatable together relative to the frame 102 in a rotational direction R. The disc 105 can rotate in an opposite direction in other examples.

FIG. 2 also shows that the disc 105 can be connected to a shaft 120 (distal shaft) of the spindle assembly 104 at a distal portion of the shaft 120, which can be secured using fasteners or the like. This connection between the shaft 120 and the disc 105 can allow the disc 105 to rotate with the shaft 120 and with the spindle assembly 104 with respect to the frame 102.

FIG. 3 illustrates an enlarged top isometric view of a portion of the disc mulcher 100A with the cover 108 removed. The disc mulcher 100A of FIG. 3 can be consistent with the disc mulcher 100A of FIGS. 1 and 2; FIG. 3 shows additional details of the disc mulcher. For example, FIG. 3 shows that the spindle assembly 104 can include a shaft 121 (proximal shaft), a driven pulley 122, a coupler 124, and a mounting flange 126.

The driven pulley 122 can be a pulley or gear connected to the shaft 121 and to the coupler 124. The coupler 124 can be connected to the mounting flange 126, which can be configured to receive bolts (or other fasteners) to secure the flange 126 and the spindle assembly 104 to the frame 102. The coupler 124 can connect the shaft 121 to the shaft 120 (of FIG. 2) to connect the disc 105 to the flange 126 and to the frame 102 and to connect the disc 105 to the driven pulley 122. Optionally, the coupler 124 can be removed and a single shaft can be used instead of multiple shafts (i.e., shafts 120 and 121).

FIG. 3 also shows that the motor assembly 106 can include a motor 128, a drive pulley 130, and a mounting flange 132. The motor 128 can be a hydraulic variable speed motor, such as a two-speed or two-stage hydraulic motor. The motor 128 can be connected to hydraulic lines of a skid steer for transmission of pressurized hydraulic fluid to drive the motor 128. The motor 128 can be other motor types such as an electric motor with a variable speed drive (or a variable frequency drive, an adjustable speed drive, or the like).

The drive pulley 130 can be a pulley or gear similar to the driven pulley 122. The drive pulley 130 can have a smaller diameter than the driven pulley 122. In some examples, the drive pulley 130 can be the same size or larger than the driven pulley 122. In some examples, the drive pulley 130 can have a circumference that is smaller than a circumference of the driven pulley 122 to allow the drive pulley 130 to spin at a relatively higher speed than the driven pulley 122, allowing a high-speed motor to be used to drive the disc 105 to rotate.

The drive pulley 130 can connect to the driven pulley 122 via a belt 134, which can optionally be a chain or other connector. The flange 132 can be connected to the motor 128 and the flange 132 can be configured to receive bolts or fasteners therein or therethrough to secure the flange 132 (and the motor assembly 106) to the frame 102.

The frame 102 can optionally include a support or motor mount 133 extending upward from the frame 102 to engage the flange 132. The motor mount 133 can be connected to the frame and to the flange 132 to connect the frame 102 to the motor 128. Optionally, the motor mount 133 can be movable (e.g., selectively slidable) with respect to the spindle assembly 104 (and the frame 102) to allow a user or operator to adjust a tension of the belt 134 (or chain).

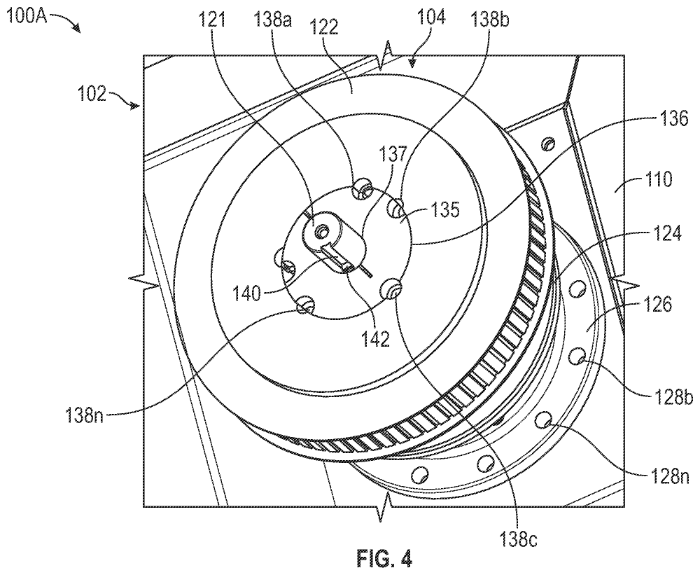

FIG. 4 illustrates an enlarged top isometric view of a portion of the disc mulcher 100A. The disc mulcher 100A of FIG. 4 can be consistent with the disc mulcher 100A of FIGS. 1-3; FIG. 4 shows additional details of the spindle assembly 104. For example, FIG. 4 shows that the flange 126 can include bores 128a-128n that can receive bolts or screws to secure the flange 126 to the frame 102.

FIG. 4 also shows that the driven pulley 122 can be indirectly connected to the motor 128 and shows that the shaft (driven shaft) 121 can be connected to the driven pulley 122, where the distal portion 120 can be connected to disc 105. FIG. 4 also shows a spindle hub (or bushing) 135 defining a shaft bore 137 extending therethrough. The proximal portion of the driven shaft 121 can extend into the shaft bore 137 to connect the driven shaft 121 to the spindle hub 135.

FIG. 4 also shows that the driven pulley 122 can define a hub bore 136. The spindle hub 135 can be located at least partially within the hub bore 136 to connect the driven pulley 122 to the spindle hub 135. A radially outer portion of the spindle hub 135 and a radially inner portion of the driven pulley 122 can together define bores 138a-138n that can be optionally threaded. The bores 138 can be configured to receive a bolts (or screws or pins) therein to secure the driven pulley 122 to the spindle hub 135.

FIG. 4 also shows that the proximal portion of the driven shaft 121 can define a slot 140 that can extend axially along an outer surface of the proximal portion 121. The hub 135 can include a projection 142 that can extend radially inward from the hub 135 into the bore 137 and into the slot 140 of the shaft to form a keyed engagement between the shaft 121 and the hub 135. Such a keyed engagement can help to transfer rotational forces between the driven pulley 122, the hub 135, and the shaft 121. Optionally, a key that is not formed with the hub 135 can be used in lieu of the projection 142, where the key can be connected to the hub 135, such as using a bolt.

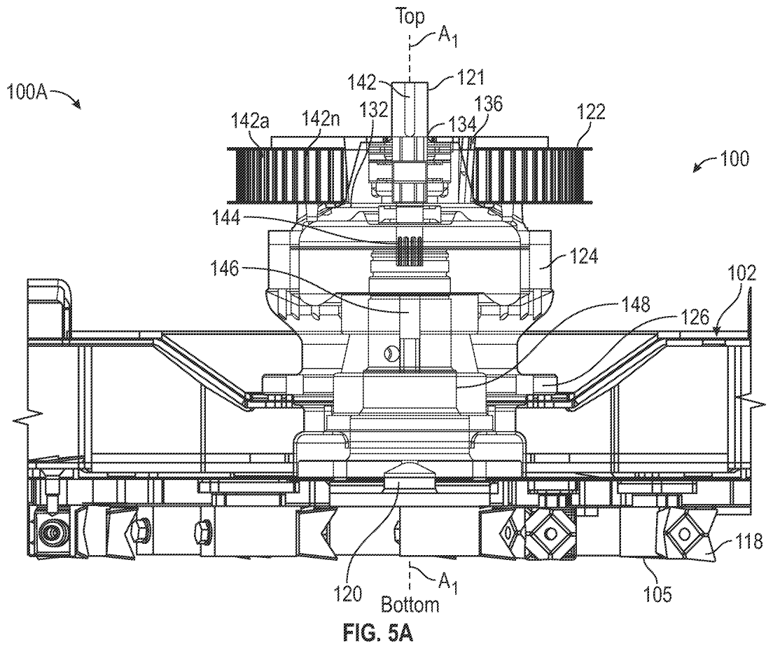

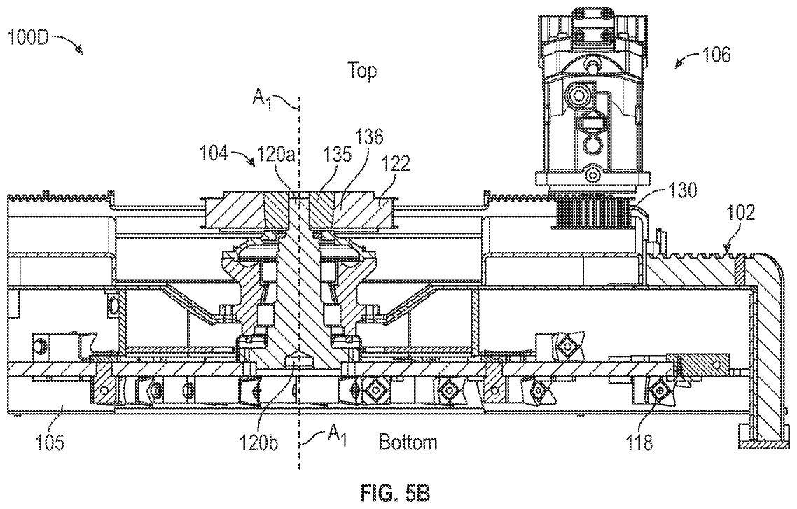

FIG. 5A illustrates a cross-sectional view of a portion of the disc mulcher 100A. The disc mulcher 100A of FIG. 5A can be consistent with the disc mulcher 100A of FIGS. 1-4; FIG. 5A shows additional details of the spindle assembly 104. For example, FIG. 5A shows that the hub bore 136 can be tapered to extend radially inward as the bore extends from top to bottom. Also, the hub 135 can have a taper that is complimentary to the hub bore 136 such that the spindle hub 135 and the hub bore 136 can engage in a taper-to-taper interface when the hub 135 is inserted into the hub bore 136. Such a taper-to-taper interface can help orient and seat the hub 135 in the bore 136 properly.

FIG. 5A also shows that the driven pulley 122 can include teeth or ribs 142a-142n that can be configured to engage complimentary teeth or ribs of the belt 134 to help limit slippage of the belt 134 with respect to the driven pulley 122. The drive pulley 130 can also include teeth or ribs.

FIG. 5A also shows a distal portion 144 of the proximal shaft 121 that can connect to the coupler 124. The coupler 124 can include a shaft 146 that can connect to a hub assembly 148 of the disc 105 to connect the proximal shaft 121 to the distal shaft 120 to connect the pulley 122 to the disc 105. Optionally, the coupler 124 can be omitted and the proximal shaft 121 can be connected directly to the hub 148 of the disc or can connect directly to the disc.

FIG. 5B illustrates a cross-sectional view of a portion of a disc mulcher 100D. The disc mulcher 100D of FIG. 5B can be consistent with the disc mulcher 100A of FIGS. 1A, and 2-5A; the disc mulcher 100D can differ in that the disc mulcher 100D can include a shaft 120 that is a single piece shaft. Any of the previous mulchers can be modified to include a single piece shaft.

The shaft 120 can include a proximal portion 120a (or top portion) and a distal portion 120b (or bottom portion). The top portion 120a can be connected to the driven pulley 122, such as via the spindle hub 135. Optionally, the top portion 120a can connect to the hub 135 via the hub bore 136, which can be tapered. The bottom portion 120b of the shaft 120 can be connected to the disc 105 to connect the driven pulley 122 to the disc 105. By using a single shaft, the coupler 124 can be omitted, which can help to reduce a cost of the mulcher 100D.

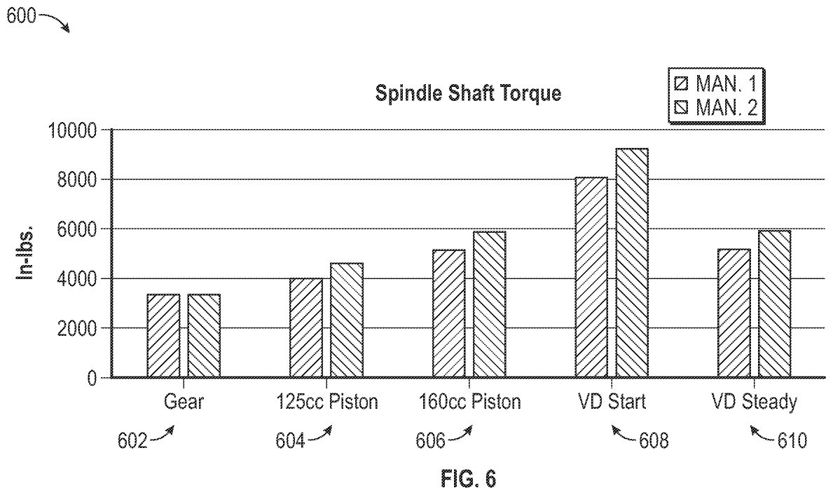

FIG. 6 illustrates a graph 600 showing operating torque of various disc mulchers when used with two popular skid steer manufacturers. More specifically, the graph 600 shows how various motors can produce spindle shaft torque. For example, a gear motor 602 can produce about 3,500 inch-pounds of torque and a 125 cubic centimeter piston motor 604 for a disc mulcher can produce between 4,000 and 5,000 inch-pounds of torque. An enlarged piston motor 606, for example 160 cubic centimeter motor, can produce between 5,000 and 6,000 inch-pounds of torque. The variable drive (VD) type motor 608 used in the disc mulcher 100A can produce between 8,000 and 10,000 inch-pounds of torque at startup and between 5,000 and 6,000 inch-pounds of torque during steady state operation 608, which is as much or more than an enlarged 160 cubic centimeter motor. FIG. 6 thereby illustrates that a smaller motor can be used to generate as much or more torque than a larger direct-drive motor, which can help to improve mulching performance while helping to save motor cost.

### NOTES AND EXAMPLES

The following, non-limiting examples, detail certain aspects of the present subject matter to solve the challenges and provide the benefits discussed herein, among others.

Example 1 is a disc mulcher connectable to a carrier vehicle, the disc mulcher comprising: a frame connectable to the skid steer; a spindle assembly connected to the frame; a disc connected to spindle assembly and rotatable relative to the frame about a central axis of the disc and the spindle assembly; and a variable speed motor connected to the frame and indirectly coupled to the spindle assembly, the variable speed motor operable to rotate the disc.

In Example 2, the subject matter of Example 1 optionally includes wherein the spindle assembly comprises: a driven pulley indirectly connected to the variable speed motor; and a driven shaft connected to the frame and including a proximal portion connected to the driven pulley and a distal portion connected to disc.

In Example 3, the subject matter of Example 2 optionally includes a drive pulley connected to the variable speed motor; and a belt or chain connected to the drive pulley and the driven pulley.

In Example 4, the subject matter of Example 3 optionally includes a spindle hub defining a shaft bore extending therethrough, the proximal portion of the driven shaft extending into the shaft bore to connect the driven shaft to the spindle hub.

In Example 5, the subject matter of Example 4 optionally includes wherein the driven pulley defines a hub bore, the spindle hub located at least partially within the hub bore to connect the driven pulley to the spindle hub.

In Example 6, the subject matter of Example 5 optionally includes wherein the hub bore is tapered and an outer portion of the spindle hub is tapered complimentary to the hub bore such that the spindle hub and the hub bore engage in a taper-to-taper interface.

In Example 7, the subject matter of any one or more of Examples 4-6 optionally include wherein: the proximal portion of the driven shaft defines a slot extending axially along an outer surface of the proximal portion; and the hub includes a projection extending radially into the slot.

In Example 8, the subject matter of any one or more of Examples 4-7 optionally include wherein the spindle hub and the driven pulley together define a plurality of threaded bores to receive a plurality of threaded bolts therein to secure the driven pulley to the spindle hub.

In Example 9, the subject matter of any one or more of Examples 4-8 optionally include wherein the drive pulley has a circumference smaller than a circumference of the driven pulley.

In Example 10, the subject matter of any one or more of Examples 1-9 optionally include wherein the variable speed motor is connected to the frame at a location laterally offset from the central axis.

In Example 11, the subject matter of any one or more of Examples 1-10 optionally include where in the variable speed motor and spindle assembly define a viewing area for a front portion of the disc which is unobstructed by the variable speed motor.

In Example 12, the subject matter of any one or more of Examples 1-11 optionally include a motor mount connected to the frame and to the motor, the motor mount movable with respect to the spindle assembly to adjust a tension of a belt or chain connecting the spindle assembly to the motor.

In Example 13, the subject matter of any one or more of Examples 1-12 optionally include wherein the variable speed motor is a hydraulic two stage motor.

Example 14 is a disc mulcher connectable to a carrier vehicle, the disc mulcher comprising: a frame assembly; a spindle assembly including a bearing connected to the frame assembly; a disc connected to spindle assembly and rotatable relative to the frame about a central axis of the disc; and a variable speed motor connected to the frame assembly and coupled to the spindle assembly, the variable speed motor operable to rotate the disc.

In Example 15, the subject matter of Example 14 optionally includes wherein the spindle assembly comprises: a driven pulley indirectly connected to the variable speed motor; and a driven shaft connected to the frame and including a proximal portion connected to the driven pulley and a distal portion connected to disc.

In Example 16, the subject matter of Example 15 optionally includes a drive pulley connected to the variable speed motor; and a belt or chain connected to the drive pulley and the driven pulley.

In Example 17, the subject matter of Example 16 optionally includes a spindle hub defining a shaft bore extending therethrough, the proximal portion of the driven shaft extending into the shaft bore to connect the driven shaft to the spindle hub.

In Example 18, the subject matter of Example 17 optionally includes wherein the driven pulley defines a hub bore, the spindle hub located at least partially within the hub bore to connect the driven pulley to the spindle hub.

In Example 19, the subject matter of Example 18 optionally includes wherein the hub bore is tapered and an outer portion of the spindle hub is tapered complimentary to the hub bore such that the spindle hub and the hub bore engage in a taper-to-taper interface.

In Example 20, the subject matter of Example 19 optionally includes together define a plurality of threaded bores to receive a plurality of threaded bolts therein to secure the driven pulley to the spindle hub.

In Example 21, the subject matter of Example 20 optionally includes wherein the drive pulley has a circumference smaller than a circumference of the driven pulley.

In Example 22, the subject matter of Example 21 optionally includes wherein the variable speed motor is connected to the frame at a location laterally offset from the central axis.

Example 23 is a disc mulcher connectable to a carrier vehicle, the disc mulcher comprising: a frame connectable to the skid steer; a spindle assembly connected to the frame; a disc connected to spindle assembly and rotatable relative to the frame about a central axis of the disc and the spindle assembly; and a motor connected to the frame at a location laterally offset from the central axis and indirectly coupled to the spindle assembly, the motor operable to rotate the disc.

In Example 24, the subject matter of Example 23 optionally includes wherein the spindle assembly comprises: a driven pulley indirectly connected to the motor; and a driven shaft connected to the frame and including a proximal portion connected to the driven pulley and a distal portion connected to disc.

In Example 25, the subject matter of Example 24 optionally includes a drive pulley connected to the motor; and a belt or chain connected to the drive pulley and the driven pulley.

In Example 26, the subject matter of Example 25 optionally includes a spindle hub defining a shaft bore extending therethrough, the proximal portion of the driven shaft extending into the shaft bore to connect the driven shaft to the spindle hub.

In Example 27, the subject matter of Example 26 optionally includes wherein the driven pulley defines a hub bore, the spindle hub located at least partially within the hub bore to connect the driven pulley to the spindle hub.

In Example 28, the subject matter of Example 27 optionally includes wherein the hub bore is tapered and an outer portion of the spindle hub is tapered complimentary to the hub bore such that the spindle hub and the hub bore engage in a taper-to-taper interface.

In Example 29, the subject matter of any one or more of Examples 23-28 optionally include a transmission connected to the hub assembly and connected to the motor to indirectly couple the motor to spindle assembly.

In Example 30, the subject matter of any one or more of Examples 23-29 optionally include wherein the transmission is a planetary gear transmission connected to the spindle assembly and connected to the motor.

Example 31 is a disc mulcher connectable to a carrier vehicle, the disc mulcher comprising: a frame connectable to the skid steer; a spindle assembly connected to the frame; a disc connected to spindle assembly and rotatable relative to the frame about a central axis of the disc and the spindle assembly; and a variable speed motor connected to the frame and coupled to the spindle assembly, the variable speed motor operable to rotate the disc.

In Example 32, the subject matter of Example 31 optionally includes wherein the variable speed motor is one of a hydraulic two stage motor and an electric motor.

In Example 33, the apparatuses or method of any one or any combination of Examples 1-32 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A disc mulcher connectable to a carrier vehicle, the disc mulcher comprising:
a frame connectable to the skid steer;
a spindle assembly connected to the frame;
a disc connected to spindle assembly and rotatable relative to the frame about a central axis of the disc and the spindle assembly; and
a variable speed motor connected to the frame and indirectly coupled to the spindle assembly, the variable speed motor operable to rotate the disc.

2. The disc mulcher of claim 1, wherein the spindle assembly comprises:
a driven pulley indirectly connected to the variable speed motor; and
a driven shaft connected to the frame and including a proximal portion connected to the driven pulley and a distal portion connected to disc.

3. The disc mulcher of claim 2, further comprising:
a drive pulley connected to the variable speed motor; and
a belt or chain connected to the drive pulley and the driven pulley.

4. The disc mulcher of claim 3, further comprising:
a spindle hub defining a shaft bore extending therethrough, the proximal portion of the driven shaft extending into the shaft bore to connect the driven shaft to the spindle hub.

5. The disc mulcher of claim 4, wherein the driven pulley defines a hub bore, the spindle hub located at least partially within the hub bore to connect the driven pulley to the spindle hub.

6. The disc mulcher of claim 5, wherein the hub bore is tapered and an outer portion of the spindle hub is tapered complimentary to the hub bore such that the spindle hub and the hub bore engage in a taper-to-taper interface.

7. The disc mulcher of claim 4, wherein:
the proximal portion of the driven shaft defines a slot extending axially along an outer surface of the proximal portion; and
the hub includes a projection extending radially into the slot.

8. The disc mulcher of claim 4, wherein the spindle hub and the driven pulley together define a plurality of threaded bores to receive a plurality of threaded bolts therein to secure the driven pulley to the spindle hub.

9. The disc mulcher of claim 4, wherein the drive pulley has a circumference smaller than a circumference of the driven pulley.

10. The disc mulcher of claim 1, wherein the variable speed motor is connected to the frame at a location laterally offset from the central axis.

11. The disc mulcher of claim 1, where in the variable speed motor and spindle assembly define a viewing area for a front portion of the disc which is unobstructed by the variable speed motor.

12. The disc mulcher of claim 1, a motor mount connected to the frame and to the motor, the motor mount movable with respect to the spindle assembly to adjust a tension of a belt or chain connecting the spindle assembly to the motor.

13. The disc mulcher of claim 1, wherein the variable speed motor is a hydraulic two stage motor.

14. A disc mulcher connectable to a carrier vehicle, the disc mulcher comprising:
a frame assembly;
a spindle assembly including a bearing connected to the frame assembly;
a disc connected to spindle assembly and rotatable relative to the frame about a central axis of the disc; and
a variable speed motor connected to the frame assembly and coupled to the spindle assembly, the variable speed motor operable to rotate the disc.

15. The disc mulcher of claim 14, wherein the spindle assembly comprises:
a driven pulley indirectly connected to the variable speed motor; and
a driven shaft connected to the frame and including a proximal portion connected to the driven pulley and a distal portion connected to disc.

16. The disc mulcher of claim 15, further comprising:
a drive pulley connected to the variable speed motor; and
a belt or chain connected to the drive pulley and the driven pulley.

17. The disc mulcher of claim 16, further comprising:
a spindle hub defining a shaft bore extending therethrough, the proximal portion of the driven shaft extending into the shaft bore to connect the driven shaft to the spindle hub.

18. The disc mulcher of claim 17, wherein the driven pulley defines a hub bore, the spindle hub located at least partially within the hub bore to connect the driven pulley to the spindle hub.

19. The disc mulcher of claim 18, wherein the hub bore is tapered and an outer portion of the spindle hub is tapered complimentary to the hub bore such that the spindle hub and the hub bore engage in a taper-to-taper interface.

20. The disc mulcher of claim 19, wherein the spindle hub and the driven pulley together define a plurality of threaded bores to receive a plurality of threaded bolts therein to secure the driven pulley to the spindle hub.
